(19) United States
(12) Patent Application Publication
(10) Pub. No.: US 2014/0162557 A1
(43) Pub. Date: Jun. 12, 2014

(54) PORTLESS ELECTRONIC DEVICES

(71) Applicant: HzO, Inc., Draper, UT (US)

(72) Inventor: Paul S. Clayson, Draper, UT (US)

(73) Assignee: HzO, Inc., Draper, UT (US)

(21) Appl. No.: 14/178,083

(22) Filed: Feb. 11, 2014

Related U.S. Application Data
(63) Continuation of application No. PCT/US13/33732, filed on Mar. 25, 2013.
(60) Provisional application No. 61/615,132, filed on Mar. 23, 2012.

(51) Int. Cl. H04M 1/18; H04M 1/215; H04M 1/02

(52) U.S. Cl. CPC H04M 1/18; H04M 1/0262; H04M 1/215
USPC 455/41.2; 455/575.8; 455/569.1; 455/572; 455/573

(57) ABSTRACT

A portable electronic device includes an outer assembly that lacks ports or other openings through which water or fluids may enter into an interior of the portable electronic device, which is defined by the outer assembly and, thus, into the presence of electronic components within the interior of the portable electronic device. The outer assembly may only include a display and a housing, or it may additionally include a waterproof microphone and at least one waterproof speaker. A protective coating, such as a moisture resistant film or coating, may coat some or all of the internal electronic components and/or some or all of the internal surfaces of the outer assembly.

### CROSS-REFERENCE TO RELATED APPLICATIONS

This application is a continuation of International Patent Application No. PCT/US2013/033732, filed in the United States on Mar. 25, 2013 and titled “PORTLESS ELECTRONIC DEVICES” (“the PCT Application”), which claims the benefit of U.S. Provisional Patent Application No. 61/615,132, filed on Mar. 23, 2012 and titled “PORTLESS ELECTRONIC DEVICES” (“the '132 Provisional Application”). The entire disclosures of the '132 Provisional Application and the PCT Application are, by this reference, incorporated herein and made a part of this specification.

### TECHNICAL FIELD

This disclosure relates generally to portable electronic devices and, more specifically, to portable electronic devices configured to withstand a variety of environmental conditions, including, but not limited to, exposure to moisture. In various embodiments, such a portable electronic device may lack ports or other openings through which environmental conditions, such as moisture, may be transmitted from an exterior of the portable electronic device to an interior of the portable electronic device.

### SUMMARY

A portable electronic device of this disclosure may include an outer assembly that lacks ports and other openings. Such a portable electronic device may also be referred to herein as a “portless electronic device.” As used herein, the term “port” refers to ports that are configured to mechanically couple with other apparatuses, such as connectors and their associated cables or electronic components. While a portless electronic device may be “portless” in the sense that it lacks ports that are configured to mechanically couple with other apparatuses, a portless electronic device may include components that enable wireless communication with other devices (e.g., radios, or transceivers; etc.), which are sometimes referred to as “virtual ports” (i.e., ports that are simulated, or that perform the functions of a port without really being a port).

A variety of different types of electronic devices fall within the scope of the teachings of this disclosure, including devices that are configured for wireless communication. Some non-limiting examples of such devices include mobile telephones, digital media players and mobile computing devices (e.g., tablet computers, smart phones, etc.).

The outer assembly of a portless electronic device defines an exterior of the portable electronic device, and defines and contains (or substantially contains) an interior of the portless electronic device. In some embodiments, the outer assembly of a portless electronic device may consist essentially of a housing. In such embodiments, the housing may include a display or at least one transparent area through which a display may be viewed. In other embodiments, the outer assembly of a portless electronic device may consist essentially of a housing and a display. Non-essential elements that are exposed to or form part of the outer assembly of a portless electronic device may include one or more buttons, features that facilitate access to an interior of the portless electronic device, one or more electrical contacts, one or more heat sinks, one or more visual indicators, and the like. Alternatively, the outer assembly of a portless electronic device may consist of a housing, a housing and a display or a housing, a display and at least one button (e.g., a virtual button of a capacitive touchscreen, a physical button that prevents the ingress of moisture into the portless electronic device, etc.).

In other embodiments, a portless electronic device may include an outer assembly with a housing, a display or a transparent area through which a display is visible, one or more audio input/output components (e.g., a microphone and one or more speakers, etc.) and a housing that lacks ports and other openings other than those needed for the display (in embodiments where such an opening is present), the audio input/output components and any other externally accessible features. The audio input/output components of such a portless electronic device may be waterproof or moisture resistant.

The outer assembly of a portless electronic device may also include one or more seals, which may be configured and/or positioned at or over seams in the housing or between the housing and other externally accessible components (e.g., the display, any audio input/output components, any buttons, any indicators, etc.) to prevent the communication of fluid (e.g., liquid, vapor, etc.) through such seams and, in some embodiments, to render the portless electronic device moisture resistant, or even waterproof. Thus, the seals may inhibit the ingress or fluid from outside of the outer assembly into the interior of the portless electronic device, or the seals may prevent fluid from outside of the outer assembly from entering into the interior of the portless electronic device.

The interior of a portless electronic device may contain a plurality of internal electronic components, including, but not limited to, one or more circuit boards, one or more processing devices, one or more memory devices, one or more wireless communication elements and the like. In addition, a power source, such as a battery and, in some embodiments, an inductive charging device, may be located within the interior of the portless electronic device.

A portless electronic device may also include one or more protective coatings. Protective coatings (or, in some embodiments, a single protective coating) may cover or coat all or part of one or more of the internal electronic components. Additionally or in the alternative, some or all of the interior surfaces of the outer assembly may be covered or coated with one or more protective coatings.

As used herein, the term “protective coating” includes moisture resistant coatings or films, as well as other coatings or films that protect various parts of an electronic assembly from external influences. The term “moisture resistant” refers to the ability of a coating to prevent exposure of a coated element or feature to moisture. A moisture resistant coating may resist wetting or penetration by one or more types of moisture, or it may be impermeable or substantially impermeable to one or more types of moisture. A moisture resistant coating may repel one or more types of moisture. In some embodiments, a moisture resistant coating may be impermeable to, substantially impermeable to or repel water, an aqueous solution (e.g., salt solutions, acidic solutions, basic solutions, drinks, etc.) or vapors of water or other aqueous materials (e.g., humidity, fogs, mists, etc.), wetness, etc.). Use of the term “moisture resistant” to modify the term “coating” should not be considered to limit the scope of materials from which the coating protects one or more components of an electronic device. The term “moisture resistant” may also refer to the ability of a coating to restrict permeation of or repel organic liquids or vapors (e.g., organic solvents, other organic materials in liquid or vapor form, etc.), as well as a variety of other substances or conditions that might pose a threat to an electronic device or its components. Various aspects relating to the use of masks in the application of protective coatings are disclosed.

Another aspect, a water-safe electronic system, which may consist of moisture resistant components or even waterproof components, may include a portless electronic device and a wireless accessory that expands the functionality of the portless electronic device. The portless electronic device may, by itself, lack one or more components (e.g., a speaker and/or microphone of a mobile telephone, etc.) and, thus, some associated functionality that will enable the portless electronic device to operate as intended. The wireless accessory may include the component or components that the portless electronic device lacks and, when used with the portless electronic device, enable it to operate as intended. In some embodiments, the portless electronic device may comprise a component that is more expensive to repair or replace when damaged by moisture, while the wireless accessory may comprise a less expensive, more readily replaceable component.

An electronic system may include a portless electronic device with a wireless communication component. The electronic system may also include a wireless accessory configured to communicate with the portless electronic device by way of the wireless communication component.

In some embodiments, a portless electronic device may be a communication device. In use, wireless communication may be established between the portless electronic device and a wireless accessory. Signals may be communicated to or from the portless electronic device through the wireless accessory. The signals can include sound or signals representing sound (i.e., audio signals). The audio signals can enable a user of the portless electronic device to use the portless electronic device to communicate with other devices or their users. The portless electronic device can be exposed to an environment where one or more of moisture or contaminants are present that could cause damage to a conventional electronic device with ports, and such exposure can take place during use or non-use of the portless electronic device, including during charging of the portless electronic device.

Other aspects of the disclosed subject matter, as well as features and advantages of various aspects of that subject matter, will become apparent to those of ordinary skill in the art through consideration of the ensuing description, the accompanying drawings, and the appended claims.

### BRIEF DESCRIPTION OF THE DRAWINGS

In the drawings:

FIG. 1 illustrates an embodiment of a portless electronic device with an outer assembly that consists essentially of a housing;

FIG. 2 depicts an embodiment of a portless electronic device with an outer assembly that consists essentially of a housing and a display;

FIG. 3 shows an embodiment of a portless electronic device with one or more closed features exposed to and/or forming part of its outer assembly;

FIG. 4 depicts an embodiment of portless electronic device of which the outer assembly exposes or includes one or more moisture resistant or waterproof personal communication features;

FIG. 5 schematically depicts features, elements and components within an interior of a portless electronic device;

FIG. 6 schematically depicts an embodiment of portless electronic device that may be charged by way of contacts carried by its exterior; and

FIG. 7 shows an embodiment of a system including a portless electronic device and a wireless communication accessory.

### DETAILED DESCRIPTION

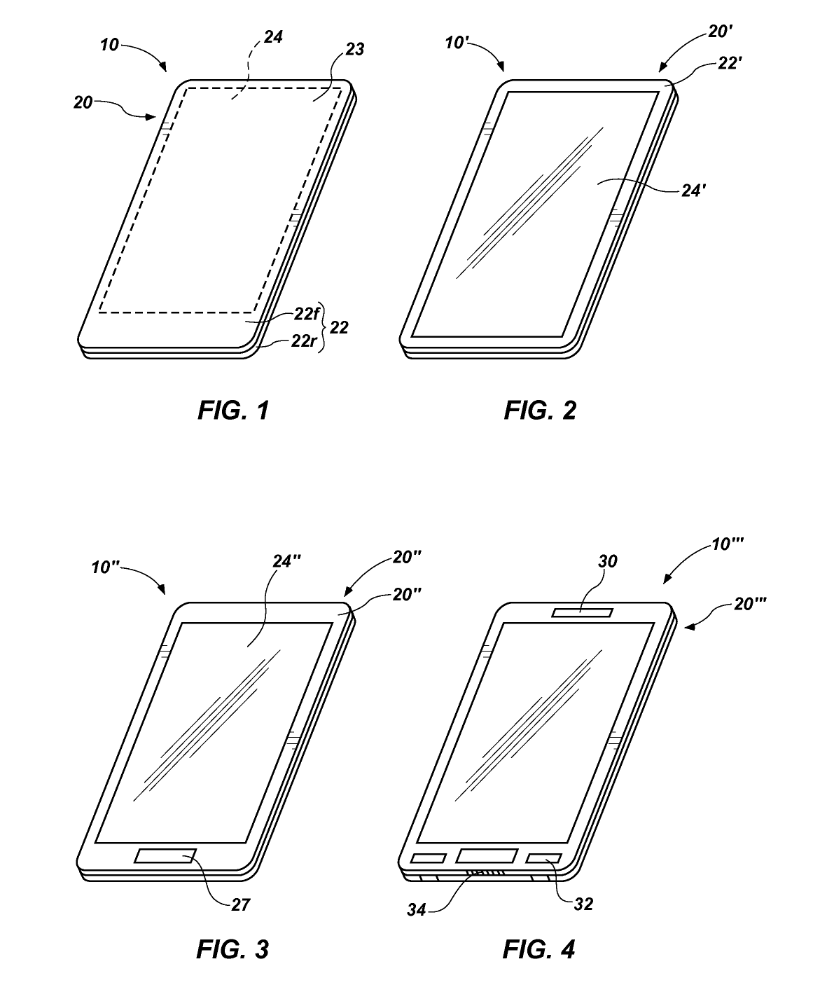

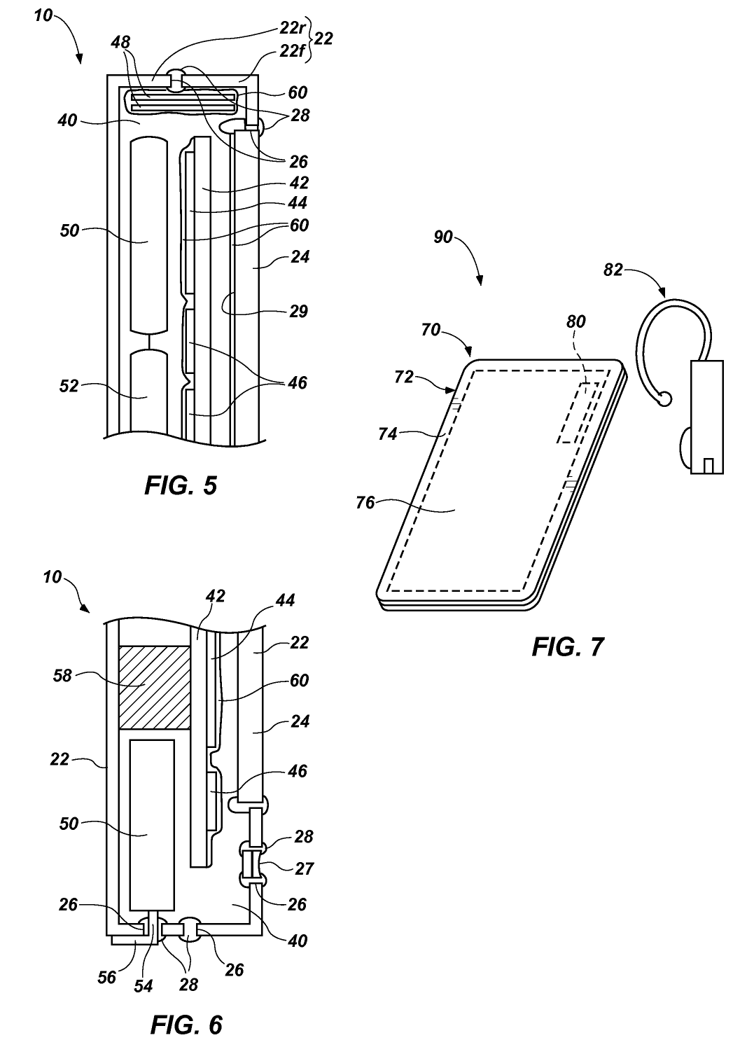

FIG. 1 illustrates an embodiment of a portless electronic device 10. The illustrated portless electronic device 10 includes an outer assembly 20 and an interior 40 (FIGS. 5 and 6). Although FIG. 1 illustrates a portless electronic device 10 that comprises a smart phone, the disclosed teachings may also be incorporated into a variety of other types of electronic devices.

The outer assembly 20 of the embodiment of portless electronic device 10 illustrated by FIG. 1 may consist essentially of a housing 22. The housing 22 may include a front piece 22f and a rear piece 22r that have been assembled with one another. The housing 22 (in FIG. 1, its front piece 22f) may include a transparent area 23 through which an internally confined display 24 is visible. The housing 22 of such an embodiment is configured to define the interior 40 of the portless electronic device 10 and to contain components, including the display 24, within the interior 40.

Alternatively, as depicted by FIG. 2, the outer assembly 20′ of a portless electronic device 10′ may consist essentially of a housing 22′ and a display 24′. Together, the housing 22′ and the display 24′ may be configured to define the interior 40′ of the portless electronic device 10 and to contain components within the interior 40′.

In addition to a housing 22, 22′ and, optionally, a display 24′, as represented by FIG. 3, the outer assembly 20″ of a portless electronic device 10″ may also include one or more closed features 27. Non-limiting examples of closed features 27 include the illustrated button (of which, a portless electronic device 10, 10′, 10″ may include one or more), electrical contacts (e.g., for charging the device while contacting complementary contacts of a charging cradle, etc.), features for accessing the interior 40 of the electronic device 10, 10′, 10″ and heat sinks, among others.

In some embodiments, such as those characterized by FIG. 4, a portless electronic device 10″′ may also include an outer assembly 20″′ that carries one or more waterproof communication features. In some embodiments, each waterproof communication feature may comprise a personal communication element configured to enable an individual to interact with and/or otherwise use the device. By way of example, and not by way of limitation, examples of waterproof communication features include speakers 30 and 32, microphones 34, as known in the art, as well as other features that may impart functionality to the portless electronic device 10″′ or enhance its functionality.

In addition to the foregoing, other embodiments of electronic devices may also incorporate teachings of this disclosure. The illustrated portless electronic devices 10, 10′, 10″, 10″′ and any other electronic device that incorporates teachings of this disclosure are, for the sake of simplicity, each referred to hereinafter as a “portless electronic device 10.” Reference to their features and parts may also be simplified in the ensuing disclosure.

Referring now to FIG. 5, the housing 22 of the outer assembly 20 (FIG. 1) of a portless electronic device 10 may be configured to minimize the number and/or size of locations through which fluids (e.g., water, water vapor, etc.) may be communicated and, thus, enter into the interior 40 of the portless electronic device 10. Thus, the housing 22 may lack any ports or other openings that would otherwise accommodate components (e.g., communication ports, battery charging ports, earphone jacks, etc.) that could enable the communication of fluids into the interior 40 of the portless electronic device 10.

In addition, the number of ports or other openings that accommodate so-called “closed” components of the portless electronic device 10 (e.g., the display 24, buttons, contacts, waterproof speakers, waterproof microphones, etc.) may be minimized. As an example, the display 24 of a portless electronic device 10 may also be configured to enable use of the portless electronic device 10 while minimizing or eliminating the number of locations through which fluids may enter the housing 22. As a specific, but non-limiting example, the display 24 of a portless electronic device 10 may be configured to minimize the inclusion of mechanical buttons, switches or other similar features, or altogether eliminate such features from the portless electronic device 10. In some embodiments, the display 24 of a portless electronic device 10 may comprise a capacitive touchscreen or any other suitable touch-sensitive display.

In addition to minimizing the number and/or extent of possible fluid paths through the housing 22, the number and/or extents of seams 26 at the exterior of the portless electronic device 10 may be minimized. Some seams 26 may be present at the exterior of a portless electronic device 10, however. One or more seams 26 may be present between various members 22f and 22r of the housing 22, between the housing 22 and other elements (e.g., the display 24, if exposed to the exterior of the portless electronic device 10; one or more closed features 27 exposed to the exterior of the portless electronic device 10; etc.) and, possibly, at other locations on the outer assembly 20.

As these seams 26 may comprise locations that are vulnerable to the inflow of fluids or other types of moisture, one or more seals 28 may be associated with each seam 26. A seal 28 may provide a barrier that prevents and/or limits the flow of liquids, vapors and/or gases from the exterior of the portless electronic device 10 into its interior 40. In some embodiments, although a seal may 28 prevent and/or limit the flow of liquids, vapors and/or gases from the interior 40, it may enable liquids, vapors and/or gases to flow from the interior 40 of a portless electronic device 10 to the environment outside of the portless electronic device 10. Alternatively, a seal 28 may prevent liquids, vapors and/or gases from flowing into and out of the interior 40 of a portless electronic device 10.

With continuing reference to FIG. 5, the interior 40 of a portless electronic device 10 may contain a plurality of internal electronic components, including, but not limited to, one or more circuit boards 42, one or more processing devices 44, one or more memory devices 46, one or more wireless communication elements 48 (e.g., antennas; transceivers or transmitters and receivers; etc.), and the like. In addition, a power source 50, such as a battery, may be located within the interior of the portless electronic device 10.

In some embodiments where the power source 50 comprises a battery, a portless electronic device 10 may include a wireless charging device 52 (e.g., an inductive charging device, etc.) in communication with the battery.

As shown in FIG. 6, in other embodiments where the power source 50 includes a battery, the battery may be charged by way of direct electrical connections. For example, a portless electronic device 10 may include a pair of electrical elements 54 that communicate with the battery, and extend from the interior 40 of the portless electronic device 10, through its housing 22, to an exterior surface of the housing 22. A pair of contacts 56 that corresponds the electrical elements 54 may be carried by the housing 22, and arranged in such a way that they will make physical contact with a charging device (not shown) when the charging device and the portless electronic device 10 are assembled with one another.

Some embodiments of portless electronic devices 10 may also include components that facilitate the transfer of heat from components within the interior 40 of the portless electronic device 10 to its exterior. For example, one or more heat sinks 58 may extend from other components within the interior 40 to the housing 22. A heat sink 58 of a known type may contact the housing 22 to transfer heat generated by one or more components within the interior 40 to the housing, which may then dissipate the heat into the environment in which the portless electronic device 10 is located. Alternatively, a heat sink 58 may be exposed directly to the environment outside of the portless electronic device 10.

With returned reference to FIG. 5, a portless electronic device 10 may also include one or more protective coatings 60. The protective coatings 60 (or, in some embodiments, a single protective coating 60) may be disposed at least partially within the interior 40 of the portable electronic device 10. One or more protective coatings 60 may cover or coat all or part of one or more of the electronic components within or exposed to the interior 40 of the portless electronic device 10. Additionally or in the alternative, some or all of the interior surfaces 29 of the outer assembly 20 may be covered or coated with one or more protective coatings 60.

The foregoing may, in various combinations, be incorporated into a variety of electronic devices.

FIG. 7 depicts a specific embodiment of portless electronic device—a mobile telephone 70—with an outer assembly 72 that may consist essentially of a housing 74 with a display 76 exposed therethrough or a housing 74 and a display 76. Thus, the mobile telephone 70 may lack any speakers and microphones.

Within its interior (not shown in FIG. 7), in addition to a variety of other components known in the art, the mobile telephone 70 may include a wireless communication component 80 that enables an individual to use the mobile telephone 70 for its intended purpose; i.e., to audibly communicate with another individual using another telephone (e.g., a BLUETOOTH transceiver, etc.). More specifically, the wireless communication component 80 may enable the mobile telephone 70 to wirelessly couple to and communicate with one or more wireless accessories 82, such as a hands-free device 82 (e.g., a wireless headset; a hands-free communication component of an audio system of an automobile, etc.) or another peripheral device. In some embodiments, the mobile telephone 70 may establish a secure personal area network with (each of) its wireless accessory(ies) 82.

Together, the mobile telephone 70 and each wireless accessory 82, or other comparable members, may comprise a water-safe electronic system 90. A more expensive component (e.g., the mobile telephone 70, etc.) of a water-safe electronic system 90 may be waterproof, while a less expensive component (e.g., the wireless accessory 82, etc.) may enable use of the more expensive component.

Although the foregoing disclosure includes many specifics, these should not be construed as limiting the scope of the disclosed subject matter or of any of the appended claims, but merely as providing information pertinent to some specific embodiments that may fall within the scopes of the appended claims. Features from different embodiments may be employed in combination. In addition, other embodiments of the disclosed subject matter may also be devised which lie within the scopes of the appended claims. The scope of each claim is, therefore, indicated and limited only by its plain language and by the equivalents to the elements of that claim. All additions, deletions and modifications to the disclosed subject matter that fall within the meaning and scopes of the claims are to be embraced by the claims.

What is claimed:

1. A portable electronic device, comprising:
an outer assembly defining an interior of the portable electronic device, the outer assembly comprising:
a housing lacking ports; and
a display;
a watertight seal located to prevent communication of fluid through a seam between the display and the housing; and
a plurality of internal electronic components sealed within the outer assembly.

2. The portable electronic device of claim 1, wherein the outer assembly consists essentially of the housing and the display.

3. The portable electronic device of claim 2, wherein the plurality of internal electronic components comprises:
a battery; and
an inductive charging device associated with the battery.

4. The portable electronic device of claim 2, further comprising:
a protective coating on at least a portion of the plurality of internal electronic components.

5. The portable electronic device of claim 4, wherein the protective coating covers only a portion of the plurality of internal electronic components.

6. The portable electronic device of claim 4, wherein an outer surface of the outer assembly lacks a protective coating.

7. The portable electronic device of claim 4, wherein the protective coating comprises a moisture resistant coating.

8. The portable electronic device of claim 1, wherein the plurality of internal electronic components includes at least one wireless communication component configured to create a secure personal area network.

9. The portable electronic device of claim 8, wherein the outer assembly lacks a microphone and a speaker.

10. The portable electronic device of claim 9, wherein the at least one wireless communication component is configured to communicate with at least one of a microphone and a speaker spaced apart from, but located in close proximity to, the outer assembly.

11. The portable electronic device of claim 9, wherein the outer assembly consists of the housing and the display.

12. The portable electronic device of claim 2, further comprising:
at least one waterproof microphone exposed at an exterior of the housing;
at least one waterproof speaker exposed at an exterior of the housing; and
watertight seals positioned to prevent communication of fluids through seams between the at least one waterproof microphone and the housing and between the at least one waterproof speaker and the housing.

13. The portable electronic device of claim 12, wherein the outer assembly consists of the display, the at least one waterproof microphone, the at least one waterproof speaker and the housing.

14. The portable electronic device of claim 1, comprising a mobile phone, a portable media player or a tablet computing device.

15. A mobile phone, comprising:
an outer assembly defining an interior of the mobile phone, the outer assembly lacking ports;
a plurality of internal components within the outer assembly, wherein the plurality of internal components comprises a wireless communication component but does not include a speaker or microphone.

16. The mobile phone of claim 15, wherein the outer assembly consists essentially of a housing with a transparent area through which a display is visible.

17. The mobile phone of claim 15, wherein the wireless communication component is configurable to communicate with a wireless accessory that enables input and output of sound.

18. The mobile phone of claim 17, wherein the outer assembly consists essentially of:
a housing;
a display; and
a watertight seal located to prevent communication of fluid through a seam between the display and the housing.

19. An electronic system, comprising:
a portless electronic device comprising a wireless communication component; and
a wireless accessory configured to communicate with the portless electronic device by way of the wireless communication component.

20. The electronic system of claim 19, wherein the wireless accessory comprises a hands-free communication component comprising a microphone.

21. The electronic system of claim 20, wherein the portless electronic device comprises a mobile telephone lacking a speaker and microphone, and wherein the wireless accessory comprises a speaker and microphone.

22. The electronic system of claim 19, wherein the portless electronic device comprises a mobile telephone comprising a speaker and microphone.

23. The electronic system of claim 19, wherein the portless electronic device comprises a portless power supply.

24. The electronic system of claim 23, wherein the portless power supply is configured to be charged by way of a wireless charging device.

25. The electronic system of claim 23, wherein the portless power supply comprises one or more electrical contacts that may be exposed through a housing of the portless electronic device.

26. A method for using a portless communication device, the method comprising:
initiating communication between the portless communication device and a wireless accessory; and
transmitting signals between the wireless accessory and the portless communication device.

27. The method of claim 26, further comprising:
while transmitting signals, exposing the portless electronic device to an environment where one or more of moisture or contaminants are present that could damage a conventional electronic device with ports.

28. The method of claim 26, wherein transmitting signals comprises transmitting an audio signal from the portless communication device to the wireless accessory.

29. The method of claim 26, wherein transmitting signals comprises transmitting an audio signal from the wireless accessory to the portless communication device.

30. The method of claim 26, further comprising:
wirelessly charging the portless communication device.
